(19) United States
(12) Patent Application Publication
(10) Pub. No.: US 2025/0383955 A1
(43) Pub. Date: Dec. 18, 2025

(54) MITIGATING SERVICE INCIDENTS USING A SCALED-DOWN SHADOW ENVIRONMENT

(71) Applicant: Microsoft Technology Licensing, LLC, Redmond, WA (US)

(72) Inventors: Weiting ZHAI, Bellevue, WA (US); Jason Brian UPHAM, Atlanta, GA (US); Karl Porus BUHARIWALA, Sammamish, WA (US); Shashwat AJMANI, Bellevue, WA (US); Xiang CHEN, Bellevue, WA (US); Hamza SAHRI, Atlanta, GA (US); Run YANG, Redmond, WA (US); Xiangqing ZHANG, Bellevue, WA (US); Laura Patrice-Ol CALLAHAN, Seattle, WA (US)

(21) Appl. No.: 18/744,556

(22) Filed: Jun. 14, 2024

(51) Int. Cl. G06F 11/07

(52) U.S. Cl. CPC G06F 11/0793; G06F 11/0712

(57) ABSTRACT

A computerized method automatically generates mitigation operations to address service incidents in a production environment. An incident associated with a service deployed in a production environment is detected. A rule associated with the service is then determined which describes a requirement of the service that must be maintained. A solution generator model is used to determine a mitigation operation to address the incident. The service is deployed to a shadow environment that is scaled down compared to the production environment. The incident is reproduced by directing traffic to the service and using a scaled-down threshold. The service is modified using the mitigation operation, and the modified service is executed in the shadow environment. If it is determined that the detected incident is addressed by the mitigation operation, the service in the production environment is modified using the mitigation operation.

### BACKGROUND

Service issues in large enterprise environments can be difficult to resolve. While artificial intelligence (AI) tools can suggest actions to restore a service, such AI-generated actions are not guaranteed to work. Further, it is challenging and resource intensive to evaluate and select an appropriate action to address the service issues.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for automatically generating and testing mitigation operations to address service incidents in a production environment is described. An incident associated with a service deployed in a production environment is detected. A rule associated with the service is then determined which describes a requirement of the service that must be maintained throughout any mitigation operation. The determined rule and incident data of the incident are provided as input to a solution generator model, which is used to determine a mitigation operation to address the incident. The determined mitigation operation satisfies the determined rule. The service is deployed to a shadow environment that is scaled down compared to the production environment. The service in the shadow environment is modified using the determined mitigation operation and the modified service is then executed in the shadow environment, including the direction of duplicate traffic to the modified service in order to test the modified service. It is determined that the detected incident is addressed with respect to the modified service deployed to the shadow environment and, as a result, the service deployed to the production environment is modified using the determined mitigation operation.

### BRIEF DESCRIPTION OF THE DRAWINGS

The present description will be better understood from the following detailed description read considering the accompanying drawings, wherein:

FIG. 1 is a block diagram illustrating an example system configured for generating and testing mitigation operations to address service incidents in an environment;

FIG. 2 is a flowchart illustrating an example process for generating and testing mitigation operations to address service incidents in a production environment using artificial intelligence (AI) tools and a service recovery platform;

FIG. 3 is a flowchart illustrating an example method for generating and testing a mitigation operation to address a service incident in an environment;

FIG. 4 is a flowchart illustrating an example method for generating and testing multiple mitigation operations to address a service incident in an environment; and

FIG. 5 illustrates an example computing apparatus as a functional block diagram.

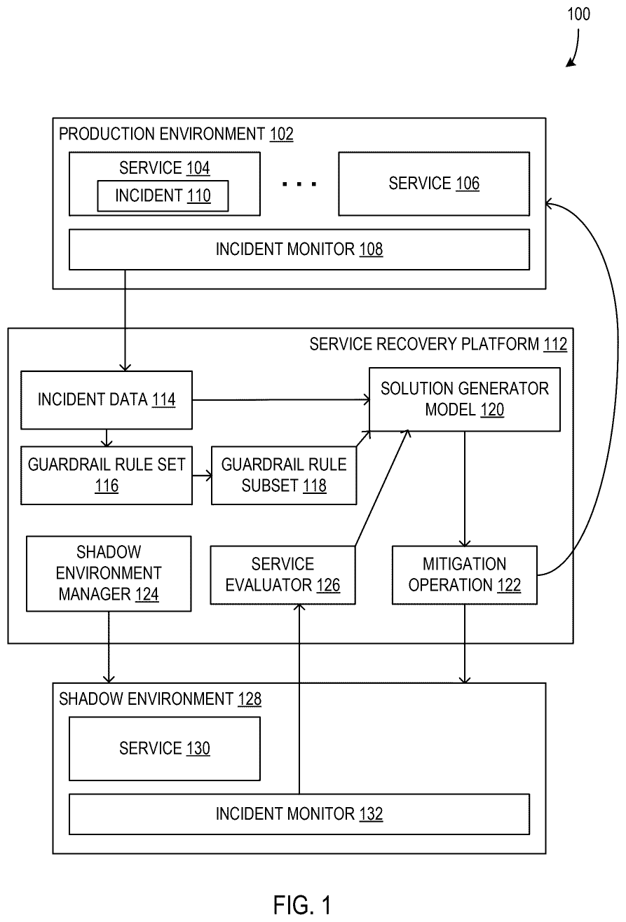

Corresponding reference characters indicate corresponding parts throughout the drawings. In FIGS. 1 to 5, the systems are illustrated as schematic drawings. The drawings may not be to scale. Any of the figures may be combined into a single example or embodiment.

### DETAILED DESCRIPTION

Aspects of the disclosure provide systems and methods for automatically addressing service incidents and issues in production domains. After a service incident is detected, a set or group of guardrail rules associated with the service are determined and a mitigation operation is generated using a solution generator model. The solution generator model is configured to generate the mitigation operation in such a way that the set of guardrail rules of the service are expected to be satisfied after the mitigation operation has been applied to the service. A shadow environment is used to evaluate the mitigation operation. The shadow environment is a scaled down version of the production environment. For example, a scale factor is applied to computing resources available to the shadow environment, to the quantity of traffic directed to the shadow environment, and/or to the threshold needed to trigger the detected incident. The service is deployed to the shadow environment and the mitigation operation is used to modify that service in the shadow environment. The modified service is executed in the shadow environment, including directing duplicate traffic to the modified service to reproduce the service incident. If it is determined that the incident is addressed with respect to the modified service in the shadow environment, the mitigation operation is used to modify the service in the production domain, thereby addressing the incident there.

Aspects of the disclosure operate in an unconventional manner at least by establishing guardrail rules for services when automatically generating mitigation operations using the solution generator model. For example, services are protected from modification when automatically addressing incidents, thereby ensuring that the generated mitigation actions are more effective against incidents less likely to cause additional issues with the services when compared to other methods. As a result, the computing resource costs and time required to automatically identify an effective mitigation operation are reduced as mitigation operations that would be ineffective or cause additional issues are prevented.

Further, examples of the disclosure enable the use of a scaled down shadow environment, wherein guardrail rule thresholds are also scaled down to enable accurate emulation of the service in the production environment and detection of incidents, at a lower traffic level. For example, the degree to which duplicate traffic is directed to the modified service in the shadow environment is also affected by the scale factor of the shadow environment. By using a scaled down shadow environment with reduced traffic and reduced thresholds for detecting incidents, the effects of a mitigation operation can be observed without the computing resource costs associated with testing in a full production environment. Therefore, the use of system resources is reduced by operation of examples of the disclosure in comparison to other systems, thereby improving the functioning of the underlying computing device.

Aspects of the disclosure describe the deployment of a service to a shadow environment and the direction of duplicate network traffic to the service to observe the effects of a proposed mitigation operation. Aspects of the disclosure evaluate the effects of an automatically generated incident mitigation operation. Specifically, the quantity of duplicate network traffic directed to the service deployed in the shadow environment is limited based on a scale factor of the shadow environment, which avoids excess traffic volume to the shadow environment and hindrance of network performance. The performance of the modified service in the shadow environment is then used to analyze whether the incident has been addressed by the mitigation operation. This provides a specific improvement over prior systems, resulting in improved evaluation of the effects of the generated mitigation operations. Thus, the described processes are integrated into a practical application.

FIG. 1 is a block diagram illustrating an example system 100 configured for generating and testing mitigation operations 122 to address service incidents 110 in an environment 102. In some examples, the system 100 includes a production environment 102 upon which services 104-106 are executed. An incident 110 associated with service 104 is detected by an incident monitor 108 and incident data 114 of the incident 110 is provided to a service recovery platform 112. The service recovery platform 112 determines a guardrail rule subset 118 that is applicable to the incident 110 from a guardrail rule set 116. The incident data 114 and the guardrail rule subset 118 are provided as input to the solution generator model 120 and the solution generator model 120 generates a mitigation operation 122 based on that input. In order to evaluate the effectiveness of the mitigation operation 122, a shadow environment manager 124 of the service recovery platform 112 creates or accesses a shadow environment 128 that closely simulates the production environment 102 and deploys a service 130 that is a clone of the service 104 to the shadow environment 128. The mitigation operation 122 is applied to the service 130 and the service 130 is executed in the shadow environment 128 in a manner that simulates the normal operation of the service 104. An incident monitor 132 monitors the operations of the service 130 and provides information about those operations to a service evaluator 126. If the service evaluator 126 determines that the service 130 is operating successfully after the mitigation operation 122, the service recovery platform 112 causes the mitigation operation 122 to be applied to the service 104. Alternatively, if the service evaluator 126 determines that the service 130 is not operating successfully after the mitigation operation 122, the service evaluator 126 causes the solution generator model 120 to generate a new mitigation operation 122 based at least in part on information associated with the operations of the service 130 after having the first mitigation operation 122 applied.

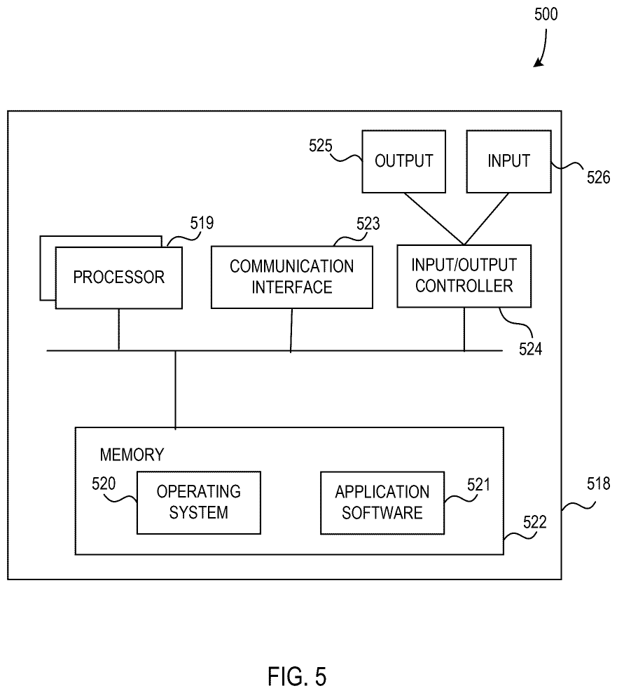

Further, in some examples, the system 100 includes one or more computing devices (e.g., the computing apparatus of FIG. 5) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the production environment 102 is executed on a first computing device and the service recovery platform 112 is located on a second computing device within the system 100. The first computing device and second computing device are configured to communicate with each other via network connections. Alternatively, in some examples, other components of the service recovery platform 112 (e.g., the solution generator model 120 and the shadow environment manager 124) are executed on separate computing devices and those separate computing devices are configured to communicate with each other via network connections during the operation of the service recovery platform 112. In other examples, other organizations of computing devices are used to implement system 100 without departing from the description.

In some examples, the production environment 102 includes hardware, firmware, and/or software that is configured to host services 104-106 and enable those hosted services 104-106 to use network connections in their operations. The production environment 102 includes network interfaces that enable input to and output from the services 104-106 to be communicated. Further, in some examples, the production environment 102 includes processing and memory resources that are provided to the services 104-106 for use in processing and storing data associated therewith.

The services 104-106 include software configured to perform operations that provide specific services to users thereof. In some examples, the services 104-106 are configured to receive input, perform an operation based on that input, and provide output of that operation. For instance, in an example, the service 104 is configured to respond to queries for information by searching and/or accessing a database based on a query and providing the results of that search in response to the query. In other examples, the services 104-106 include services configured to route data traffic in defined ways over network connections. In still other examples, other types of services are hosted in the production environment 102 without departing from the description.

The production environment 102 includes an incident monitor 108. The incident monitor 108 includes software configured to monitor the operations of the services 104-106 and to detect the occurrence of incidents such as incident 110. In some examples, the incident monitor 108 detects changes to the operations or performance of services 104-106 that differ significantly from the average operations or performance of those services 104-106 (e.g., the service 104 slowing down significantly or stopping entirely) and those changes are categorized as incidents. Additionally, or alternatively, the incident monitor 108 includes a set of performance thresholds or requirements for each service 104-106 that it evaluates to detect incidents occurring with those services 104-106.

When an incident 110 is detected by the incident monitor 108, the incident monitor 108 is configured to provide incident data 114 of the incident 110 to the service recovery platform 112. The service recovery platform 112 includes hardware, firmware, and/or software configured to generate and evaluate mitigation operations 122 in response to received incident data 114 as described herein. The incident data 114 is used in conjunction with a guardrail rule set 116 to determine a guardrail rule subset 118 of one or more guardrail rules that apply to the incident 110 and/or the service 104. In some examples, the incident data 114 includes information that is specific to the incident 110, information that identifies and describes the features of the service 104, and/or information that describes features of the production environment 102. The service recovery platform 112 uses the information in the incident data 114 to identify the guardrail rule subset 118 that will limit the mitigation operations 122 that the solution generator model 120 will generate. For instance, in an example, the service 104 requires the use of at least three parallel processes to operate and, as a result, a guardrail rule associated with the service 104 is defined that requires the quantity of parallel processes assigned to the service 104 always meet or exceed three. When handling an incident 110 of service 104, this guardrail rule is included in the guardrail rule subset 118 and provided to the solution generator model 120, which ensures that the solution generator model 120 will not generate a mitigation operation 122 that includes reducing the parallel processes of the service 104 to less than three. Further examples of guardrail rules include restrictions against rolling back to previous software versions to prevent the loss of expected functionality and/or limits on how many instances of the service that must be operational to prevent service interruption. In other examples, more, fewer, or other types of guardrail rules are used without departing from the description.

The solution generator model 120 is a trained machine learning (ML) model that is configured to analyze incident data 114 and generate a mitigation operation 122 that is likely to address the incident 110. For instance, in an example, incident data 114 associated with an incident 110 that causes the service 104 to have slow network communications causes the solution generator model 120 to generate a mitigation operation 122 that causes the service 104 to change how the data traffic is routed, increase the quantity of network connections used by the service 104, or the like. It should be understood that the solution generator model 120 is trained using data associated with a wide variety of incidents without departing from the description.

The service recovery platform 112 further includes a shadow environment manager 124. The shadow environment manager 124 is configured to generate or otherwise access a shadow environment 128 and to deploy a service 130 thereto, wherein the service 130 is a clone of the service 104 with which the incident 110 is associated. The shadow environment manager 124 then causes the service 130 to be modified using the mitigation operation 122. The modified service 130 is executed in the shadow environment 128 such that its operation closely simulates the operation of the service 104 and the performance of the modified service 130 is monitored by the incident monitor 132 of the shadow environment 128.

Additionally, or alternatively, in some examples, after the service 130 is deployed to the shadow environment 128 but prior to the service 130 being modified by the mitigation operation 122, the service 130 is executed in the shadow environment 128 to attempt to reproduce the incident 110. Through this reproduction, it is confirmed that the issue causing the incident 110 is present in the shadow environment 128 and, further, data from the reproduction can be compared to data collected from the execution of the modified service 130, thereby enabling more effective or efficient identification of incident-causing issues.

In some examples, the shadow environment 128 is configured to be the same as or similar to the production environment 102. Additionally, or alternatively, the shadow environment 128 is configured to be a scaled-down version of the production environment 102. In some such examples, the computing resources used by the production environment 102 are significant and the resource consumption associated with configuring the shadow environment 128 to be identical to the production environment 102 make it impractical. However, a shadow environment 128 is scaled down in such a way as to enable the service 130 to still be accurately tested. For instance, in an example, the shadow environment 128 is generated to make use of 25% as many resources, such as processor resources, memory resources, or the like (e.g., a scale factor of 25%). As a result of scaling down the shadow environment 128, in some examples, the deployed service 130 is also scaled down. For instance, in the above example in which the shadow environment 128 is scaled down to 25% of the production environment 102, some or all of the environment resources assigned to the service 130 are also scaled down to 25% (e.g., the service 130 is assigned only 25% of the data processing capacity that the service 104 uses in the production environment 102). Further, the threshold for triggering an incident is likewise reduced by 25% in some examples.

After the service 130 is modified by the mitigation operation 122, the modified service 130 is executed in the shadow environment 128. In some examples, executing the service 130 includes routing some data traffic that is intended for the service 104 to the modified service 130. For instance, in an example, data traffic intended for the service 104 is copied and routed to both the service 104 and the service 130. The output generated by the service 130 is then evaluated by the incident monitor 132 and/or service evaluator 126 as part of evaluating the effectiveness of the mitigation operation 122 in the shadow environment 128. Further, in some examples, the degree to which the shadow environment 128 has been scaled down is used to determine the quantity of data traffic to send to the service 130 during execution thereof (e.g., if the shadow environment 128 and the associated capabilities of the service 130 are scaled down to 25%, only 25% of the data traffic is routed to the service 130 during execution). Thus, in the above example, the shadow environment 128 is ‘scaled down’ by the scale factor of 25% by applying the scale factor to the computing resources available to the shadow environment, to the quantity of traffic directed to the service 130 and the shadow environment 128, and to the threshold needed to violate a requirement of the service 130 and hence trigger the detected incident 110.

The incident monitor 132 of the shadow environment 128 provides data associated with the execution of the service 130 (e.g., performance data of the service 130, incident data of incidents that arise during execution of the service 130, etc.) to the service evaluator 126 of the service recovery platform 112. The service evaluator 126 is configured to evaluate the data associated with the modified service 130 and determine whether the mitigation operation 122 is effective in addressing the incident 110. If the incident 110 is addressed in the service 130 based on the application of the mitigation operation 122, the service evaluator 126 causes the service recovery platform 112 to modify the service 104 using the mitigation operation 122. If the incident 110 is not addressed and/or if another incident is detected associated with the execution of the modified service 130, the service evaluator 126 causes the solution generator model 120 to generate another mitigation operation 122. In some such examples, the service evaluator 126 provides additional information to the solution generator model 120 associated with the operation of the modified service 130, such that the solution generator model 120 is enabled to use that information in the generation of a new mitigation operation 122. In this way, the service recovery platform 112 can operate in a loop until an effective mitigation operation 122 is generated or until it becomes necessary to contact an expert to deal with the incident. For example, the service recovery platform 112 is configured to try the first five generated mitigation operations 122 and if none of them are successful, the service recovery platform 112 notifies an expert to handle the incident).

Alternatively, or additionally, in some examples, the service recovery platform 112 is configured to notify an expert when a mitigation operation 122 is found to be effective at addressing the incident 110. For instance, after determining that the mitigation operation 122 is effective, the service recovery platform 112 causes an automatically generated email or other form of communication to be sent to an expert individual associated with the service 104. The expert is provided the opportunity to approve or reject the mitigation operation 122 before it is applied to the service 104. In some such examples, the notification includes information about the mitigation operation 122, such as the aspects of the service 104 that are changed by the mitigation operation 122 and/or the performance data associated with the modified service 130 being executed in the shadow environment 128.

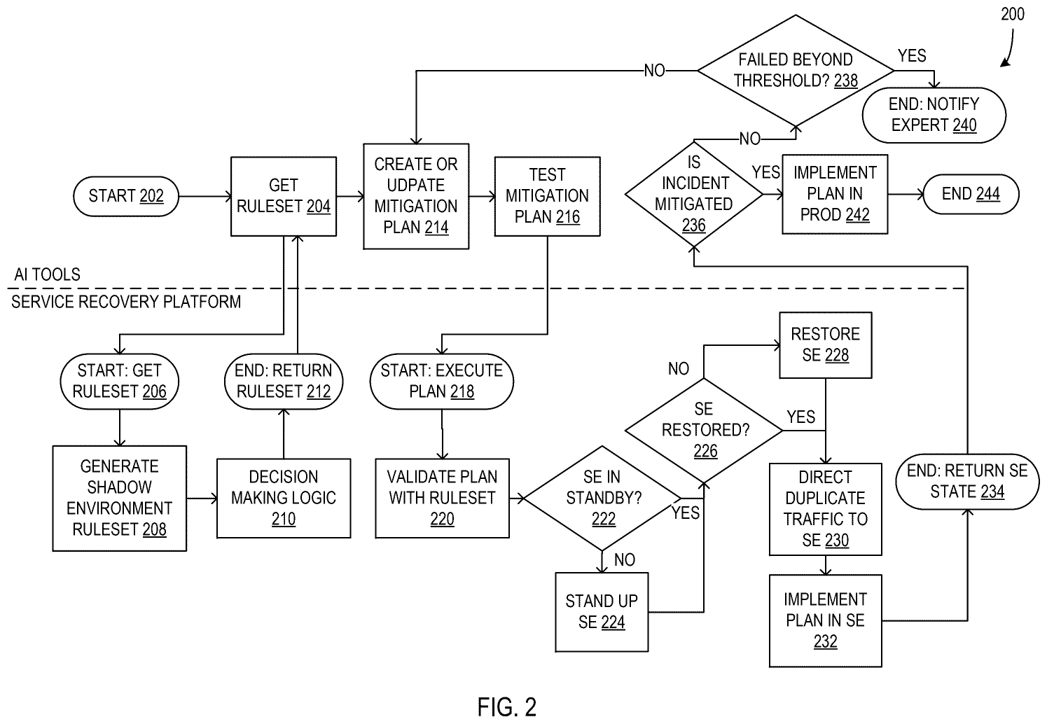

FIG. 2 is a flowchart illustrating an example process 200 for generating and testing mitigation operations to address service incidents in a production environment using artificial intelligence (AI) tools and a service recovery platform. In some examples, the process 200 is executed or otherwise performed in a system such as system 100 of FIG. 1. Further, as illustrated, some of the subprocesses of the process 200 are performed by one or more AI tools, such as a solution generator model 120, while other subprocesses of the process 200 are performed by the service recovery platform 112 as described herein. In some examples, the process 200 is triggered based on the detection of an incident 110 associated with a service 104 that is executing in an environment such as a production environment 102 as described above with respect to FIG. 1.

At 202, the process 200 begins and at 204, a get ruleset subprocess is performed on the AI Tools side (e.g., the solution generator model 120) of the system. The get ruleset subprocess communicates with the service recovery platform 112 to trigger the start of a get ruleset subprocess at 206.

At 208, a shadow environment (SE) ruleset is generated. In some examples, the SE ruleset is a guardrail rule subset 118 generated from a larger guardrail rule set 116 as described above with respect to FIG. 1. The SE ruleset is generated based on aspects of the detected incident, the service affected by the detected incident, and the environment in which the incident occurred.

At 210, decision making logic is performed. In some examples, the decision making logic is used to determine how to apply ruleset requirements in the scaled down SE. For instance, in an example, a ruleset specification limits the number of services that can be removed from DNS routing to maintain a minimum number of regions. If the scaled down SE has four regions, and the ruleset is to maintain 40% of the regions, the decision-making logic would determine that 1.6 regions need to be operational. Regions cannot be partially operational, so the decision-making logic determines that two regions must be maintained with respect to the SE to satisfy the ruleset requirement.

When the SE ruleset is generated and the decision-making logic performed, at 212, the get ruleset process of the service recovery platform ends by returning the SE ruleset to the AI tools side.

At 214, a mitigation plan is created. In some examples, the creation of the mitigation plan includes the generation of a mitigation operation 122 by a solution generator model 120 as described herein. In such examples, the mitigation operation 122 is generated as part of the mitigation plan and the mitigation plan includes one or more different operations that must be performed to implement the plan. Further, in some examples, the created mitigation plan is based at least in part on the SE ruleset that was obtained from the service recovery platform, such that the mitigation plan conforms to and/or satisfies the rules of the SE ruleset.

At 216, the AI tools side initiates the testing of the mitigation plan, which causes the execution of the mitigation plan on the service recovery platform side at 218.

At 220, the mitigation plan is validated with respect to the SE ruleset. Although the mitigation plan was created based at least in part on the SE ruleset, the service recovery platform is configured to further validate that the mitigation plan does not violate any of the rules of the SE ruleset before proceeding to further implement the mitigation plan.

At 222, the service recovery platform determines if the SE is in standby mode. If it is not in standby, then the SE has not been created or configured and the service recovery platform causes the SE to be built, developed, and/or stood up at 224 so that it can be used. After the SE is stood up or if the SE was already in standby mode at 222, the service recovery platform determines if the SE has been restored at 226. If it has not been restored, the service recovery platform restores the SE at 228. Further, in some examples, the mitigation plan includes the removal of a resource such as a region to mitigate an issue. In such examples, the configuration and/or standing up of the SE does not include setting up the infrastructure of that region to test the mitigation strategy.

After the SE has been restored at 228 or if the SE has already been restored at 226, the service recovery platform directs duplicate traffic to the SE at 230. In some examples, the duplicate traffic directed to the SE is based on the data traffic that is directed to the service 104 with which the incident 110 is associated. Further, in some examples, the duplicate traffic directed to the SE is reduced by a percentage or otherwise scaled down to account for the degree to which the SE has been scaled down in comparison to the production environment upon which the SE is based. For instance, in an example, the SE is a scaled down version of a production environment that has been scaled down to 10% of the production environment. The duplicate traffic directed to the SE is thus scaled down to 10% of the traffic that is directed to the production environment, and a threshold for triggering an incident (e.g., violating a requirement of the service) is likewise reduced to 10% of the corresponding threshold in the production environment.

At 232, the mitigation plan is implemented in the SE. In some examples, this includes the performance of one or more mitigation operations 122 on a service 130 that is a clone of the service 104 with which the incident 110 is associated. The operation(s) of the mitigation plan modify the service 130 as described herein in an effort to mitigate or otherwise address the incident 110. The duplicate data traffic directed to the SE is then processed by the modified service 130 and the results of this traffic processing are observed (e.g., by an incident monitor 132). Once a defined time threshold and/or processed data quantity threshold has been surpassed by the modified service 130 processing duplicate data traffic, the testing of the mitigation plan is complete, and the process ends by returning data indicative of the state of the SE to the AI tools side of the system at 234.

At 236, if the incident is found to not be mitigated by the mitigation plan, it is determined whether the mitigation plan failed beyond a defined threshold at 238. If the mitigation plan did not fail beyond the threshold, the process returns to 214 to create another mitigation plan or update an existing mitigation plan. Alternatively, if the mitigation plan did fail beyond the threshold, the process ends at 240 by notifying an expert of the incident and the failure of the automated mitigation plan generation process. In some examples, the threshold used at 238 is a quantity of attempted mitigation plans. For instance, if the most recent failed mitigation plan is the fourth automatically created mitigation plan that has been tried, it is determined that the mitigation plan has failed beyond the threshold. Additionally, or alternatively, in some examples, the threshold is a time threshold, such that if a defined length of time has passed since the incident was detected and a successful mitigation plan has not yet been automatically created, it is determined that the most recent mitigation plan has failed beyond the threshold. In other examples, more or different thresholds are used without departing from the description.

Alternatively, if, at 236, it is determined that the mitigation plan has mitigated the incident, the mitigation plan is implemented in the production environment at 242, thus ending the process at 244.

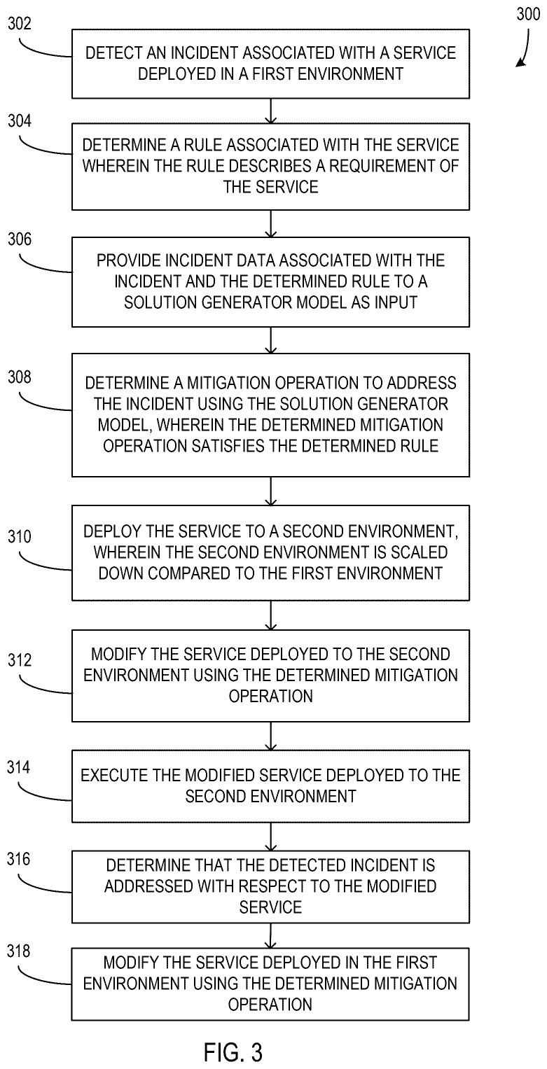

FIG. 3 is a flowchart illustrating an example method 300 for generating and testing a mitigation operation (e.g., a mitigation operation 122) to address a service incident (e.g., incident 110) in an environment (e.g., production environment 102). In some examples, the method 300 is executed or otherwise performed in a system such as system 100 of FIG. 1.

At 302, an incident associated with a service deployed in a first environment is detected. In some examples, the first environment is a production environment. Further, in some such examples, the detected incident is an incident that causes the service to halt, an incident that causes the service to slow down significantly, a user experience incident, a user interface incident, and/or an incident that causes the service to perform inaccurately (e.g., return the wrong information in response to an input query). In other examples, the detected incident is a different type of incident without departing from the description. Additionally, or alternatively, the incident is detected by an incident monitor 108 as described herein.

At 304, a rule associated with the service is determined. The rule (e.g., a guardrail rule from a guardrail rule set 116) describes a requirement of the service, such as a processing thread quantity requirement, a network port access requirement, a security level access requirement, a storage capacity requirement (e.g., cache capacity), and/or a minimum memory quantity requirement. In other examples, the determined rule is part of a plurality of rules in a guardrail rule subset 118 and/or more, fewer, or different service requirements are described by the rule or plurality of rules without departing from the description.

At 306, incident data associated with the incident and the determined rule are provided to a solution generator model as input and, at 308, a mitigation operation to address the incident is determined using the solution generator model. The determined mitigation operation is configured to satisfy the determined rule. In some examples, the solution generator model is a trained ML model and/or part of a set of AI tools used to facilitate the service in the first environment as described herein.

At 310, the service is deployed to a second environment, wherein the second environment is scaled down compared to the first environment. In some examples, the first environment is a production environment while the second environment is a shadow environment that is configured to closely emulate the production environment. Further, the service deployed to the second environment is a clone or copy of the service with which the incident is associated, though changes may be made to the service deployed to the second environment to make it compatible with the second environment.

In some examples, deploying the service to the second environment includes first creating and/or standing up the second environment. A configuration of the first environment is identified and a scale factor for the second environment is determined. In some such examples, the scale factor is based on resources used in the configuration of the first environment and on resources available for use in the configuration of the second environment. For instance, if the first environment uses a large quantity of processing, memory, and/or other system resources, the scale factor for the second environment is determined to be relatively small (e.g., 10% of the resources used in the first environment). The second environment is created using the identified configuration of the first environment such that it closely emulates the first environment, wherein the scale factor is used to scale down aspects of the second environment such that the second environment behaves similarly to the first environment but uses less resources.

Further, in some examples, a threshold for the rule is also scaled down based on the scale factor. For example, if the service deployed in the first environment requires a quantity of bandwidth during operation per the rule and the scale factor is 50%, the required quantity of bandwidth for the service in the second environment is likewise 50% relative to the quantity of bandwidth required in the first environment.

Additionally, or alternatively, in some examples, after the service is deployed to the second environment, the service is executed in the second environment to attempt to reproduce the incident detected at 302. Through this reproduction, it is confirmed that the issue causing the incident is present in the second environment and data from the reproduction can be compared to data collected from the execution of the modified service below, thereby enabling more effective or efficient identification of issues.

At 312, the service deployed to the second environment is modified using the determined mitigation operation and, at 314, the modified service is executed in the second environment. In some examples, the mitigation operation is an operation for adjusting the quantity of processing resources allocated to the service, an operation for adjusting a quantity of memory resources allocated to the service, an operation adjusting a rate at which traffic is directed to the service, an operation rolling back the service to a previous version, and/or an operation adjusting a frequency with which a subprocess of the service is performed. In other examples, the mitigation operation includes more, fewer, and/or different operations without departing from the description.

Further, in some examples, execution of the modified service includes directing duplicate traffic to the modified service deployed to the second environment. The duplicate traffic is duplicated from traffic directed to the service deployed in the first environment. Additionally, in some examples, the quantity of the duplicate traffic directed to the modified service is based on the determined scale factor, such that the modified service receives a scaled down quantity of duplicate traffic in comparison to the traffic directed to the service in the first environment. Thus, in the above example, the second environment is ‘scaled down’ by the scale factor by applying the scale factor to the computing resources available to the second environment, to the quantity of traffic directed to the service and the second environment, and to the threshold needed to violate a requirement of the service and hence trigger the detected incident.

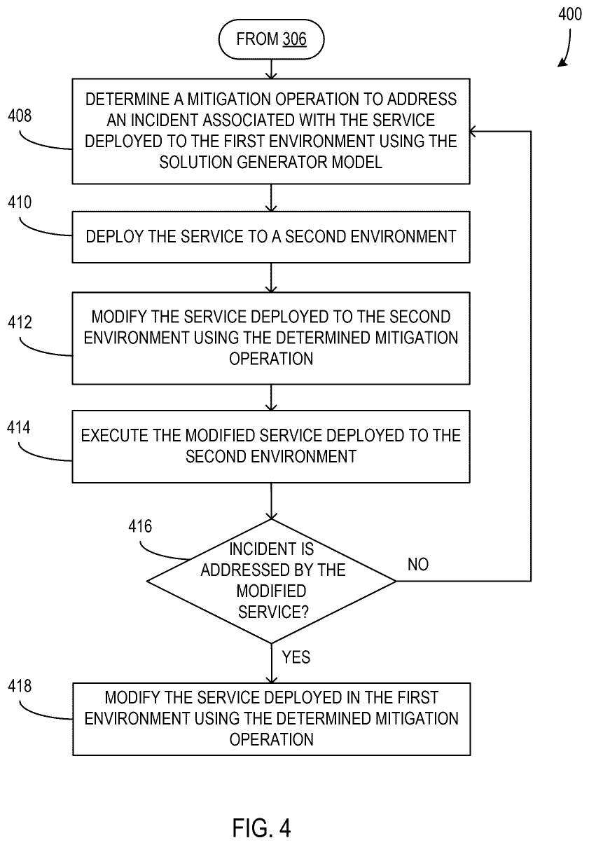

At 316, it is determined that the detected incident is addressed with respect to the modified service deployed to the second environment. In some examples, the modified service is executed for a defined quantity of time and/or the modified service is exposed to patterns of behavior and/or circumstances associated with the original occurrence of the incident. If the incident is not detected during the execution of the modified service, it is determined that the incident has been addressed. The case of the incident not being addressed is described in greater detail below with respect to FIG. 4.

At 318, as a result of the determination that the determined mitigation operation addressed the incident in the second environment, the service deployed to the first environment is modified using the determined mitigation operation and execution of that modified service is then resumed in the first environment. Thus, the incident is addressed automatically using the ML model and the automated testing using the shadow environment. Additionally, or alternatively, in some examples, the determined mitigation operation is used to change the configuration of the first environment and/or to reconfigure a device associated with the first environment to enable the device to execute the modified service. Further, in some examples, the method 300 includes causing a device, such as a device with a configuration modified based on the determined mitigation operation, to execute the modified service in the first environment.

FIG. 4 is a flowchart illustrating an example method 400 for generating and testing multiple mitigation operations (e.g., mitigation operation 122) to address a service incident (e.g., incident 110) in an environment (e.g., production environment 102). As illustrated, the method 400 begins at 408 after the performance of 306 of method 300 as described above. Further, in some examples, the method 400 is executed or otherwise performed in a system such as system 100 of FIG. 1.

At 408, a mitigation operation is determined to address the incident associated with the service deployed to the first environment using the solution generator model. In some examples, the determination of the mitigation operation is performed in substantially the same way as described above with respect to at least 308 of method 300.

At 410, the service is deployed to the second environment (e.g., the shadow environment 128) and, at 412, the service deployed to the second environment is modified using the determined mitigation operation. In some examples, 410 and 412 are performed in substantially the same way as described above with respect to at least 310 and 312, respectively.

At 414, the modified service deployed to the second environment is executed and, at 416, it is determined whether the incident is addressed by the modified service. If the modified service has addressed the incident, the process proceeds to 418, at which point, the service deployed in the first environment is modified using the determined mitigation operation. Alternatively, if the modified service has not addressed the incident, the returns to 408, at which point another mitigation operation is determined using the solution generator model. In this way, this looping method enables the automated generation of multiple mitigation operations that can be tried iteratively until the incident is addressed or until another event interrupts the loop (e.g., a mitigation operation fails beyond a defined threshold as described above with respect to 238 of process 200).

### Exemplary Operating Environment

The present disclosure is operable with a computing apparatus according to an embodiment as a functional block diagram 500 in FIG. 5. In an example, components of a computing apparatus 518 are implemented as a part of an electronic device according to one or more embodiments described in this specification. The computing apparatus 518 comprises one or more processors 519 which may be microprocessors, controllers, or any other suitable type of processors for processing computer executable instructions to control the operation of the electronic device. Alternatively, or in addition, the processor 519 is any technology capable of executing logic or instructions, such as a hard-coded machine. In some examples, platform software comprising an operating system 520 or any other suitable platform software is provided on the apparatus 518 to enable application software 521 to be executed on the device. In some examples, automatically generating and testing mitigation operations to address service incidents in production environments as described herein is accomplished by software, hardware, and/or firmware.

In some examples, computer executable instructions are provided using any computer-readable media that is accessible by the computing apparatus 518. Computer-readable media include, for example, computer storage media such as a memory 522 and communications media. Computer storage media, such as a memory 522, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium is not a propagating signal. Propagated signals are not examples of computer storage media. Although the computer storage medium (the memory 522) is shown within the computing apparatus 518, it will be appreciated by a person skilled in the art, that, in some examples, the storage is distributed or located remotely and accessed via a network or other communication link (e.g., using a communication interface 523).

Further, in some examples, the computing apparatus 518 comprises an input/output controller 524 configured to output information to one or more output devices 525, for example a display or a speaker, which are separate from or integral to the electronic device. Additionally, or alternatively, the input/output controller 524 is configured to receive and process an input from one or more input devices 526, for example, a keyboard, a microphone, or a touchpad. In one example, the output device 525 also acts as the input device. An example of such a device is a touch sensitive display. The input/output controller 524 may also output data to devices other than the output device, e.g., a locally connected printing device. In some examples, a user provides input to the input device(s) 526 and/or receives output from the output device(s) 525.

The functionality described herein can be performed, at least in part, by one or more hardware logic components. According to an embodiment, the computing apparatus 518 is configured by the program code when executed by the processor 519 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: detect an incident associated with a service deployed in a first environment; determine a rule associated with the service and the incident, wherein the rule describes a requirement of the service; provide incident data associated with the incident and the rule to a solution generator model as input; receive a mitigation operation from the solution generator model, wherein the mitigation operation is expected to satisfy the rule; configure a second environment as a scaled down version of the first environment, wherein the second environment is associated with a scaled down quantity of resources compared to the first environment; deploy the service to a second environment; detect the incident in the second environment; modify the service deployed to the second environment using the mitigation operation; execute the modified service in the second environment; determine that the incident is resolved in the second environment; and modify the service deployed in the first environment using the mitigation operation.

An example computerized method comprises detecting an incident associated with a service deployed in a first environment; determining a rule associated with the service, wherein the rule describes a requirement of the service; determining a mitigation operation to address the incident using a solution generator model, wherein the mitigation operation satisfies the rule; deploying the service to a second environment, wherein the second environment is scaled down compared to the first environment; modifying the service deployed to the second environment using the mitigation operation; directing duplicate traffic to the modified service deployed to the second environment, wherein the duplicate traffic is scaled down relative to traffic directed to the service deployed in the first environment; determining that the incident is addressed with respect to the modified service deployed to the second environment based at least in part on directing the duplicate traffic to the modified service; and modifying the service deployed in the first environment using the mitigation operation.

One or more computer storage media having computer-executable instructions that, upon execution by a processor, cause the processor to at least: determine, using a solution generator model, a first mitigation operation associated with an incident and a service deployed to a first environment, wherein the first mitigation operation satisfies a rule associated with a requirement of the service; deploy the service to a second environment, wherein the second environment is scaled down compared to the first environment; modify the service deployed to the second environment using the first mitigation operation; execute the modified service deployed to the second environment; determine that the incident is not addressed with respect to the modified service deployed to the second environment; determine a second mitigation operation to address the incident associated with the service deployed to the first environment using the solution generator model, wherein the second mitigation operation satisfies the rule; modify the service in the second environment using the second mitigation operation; execute the modified service redeployed to the second environment; determine that the incident is resolved; and modify the service deployed in the first environment using the second mitigation operation.

Alternatively, or in addition to the other examples described herein, examples include any combination of the following:
wherein the incident includes at least one of a service halt incident, a service slow down incident, a user experience incident, a user interface incident, or a service inaccuracy incident.
wherein the determined rule is associated with at least one of the following: a processing thread quantity requirement, a network port access requirement, a security level access requirement, a storage capacity requirement, or a minimum memory quantity requirement.
wherein deploying the service to the second environment includes: identifying a configuration of the first environment; determining a scale factor based on resources used in the configuration of the first environment and on resources available for use in the configuration of the second environment; and creating the second environment using the identified configuration of the first environment and the determined scale factor, wherein the second environment is scaled down from the first environment based on the determined scale factor.
wherein deploying the service to the second environment includes scaling down the determined rule using the determined scale factor; and wherein determining that the detected incident is addressed with respect to the modified service deployed to the second environment includes determining that the scaled down rule is satisfied during the directing of the duplicate traffic to the modified service deployed to the second environment.
wherein a quantity of the directed duplicate traffic to the modified service deployed to the second environment is scaled down using the determined scale factor.
wherein the determined mitigation operation includes at least one of the following: an operation adjusting a quantity of processing resources allocated to the service, an operation adjusting a quantity of memory resources allocated to the service, an operation adjusting a rate at which traffic is directed to the service, an operation rolling back the service to a previous version, or an operation adjusting a frequency with which a subprocess of the service is performed.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting an incident associated with a service deployed in a first environment; an exemplary means for determining a rule associated with the service wherein the rule describes a requirement of the service; an exemplary means for determining a mitigation operation to address the incident using a solution generator model, wherein the determined mitigation operation satisfies the determined rule; an exemplary means for deploying the service to a second environment, wherein the second environment is scaled down compared to the first environment; an exemplary means for modifying the service deployed to the second environment using the determined mitigation operation; an exemplary means for directing duplicate traffic to the modified service deployed to the second environment, wherein the duplicate traffic is duplicated from traffic directed to the service deployed in the first environment; an exemplary means for determining that the detected incident is addressed with respect to the modified service deployed to the second environment; and an exemplary means for modifying the service deployed in the first environment using the determined mitigation operation.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

1. A system comprising:
a processor; and
a memory comprising computer program code, the memory and the computer program code configured to cause the processor to:
detect an incident associated with a service deployed in a first environment;
determine a rule associated with the service and the incident, wherein the rule describes a requirement of the service;
provide incident data associated with the incident and the rule to a solution generator model as input;
receive a mitigation operation from the solution generator model, wherein the mitigation operation is expected to satisfy the rule;
configure a second environment as a scaled down version of the first environment, wherein the second environment is associated with a scaled down quantity of resources compared to the first environment;
deploy the service to the second environment;
detect the incident in the second environment;
modify the service deployed to the second environment using the mitigation operation;
execute the modified service in the second environment;
determine that the incident is resolved in the second environment; and
modify the service deployed in the first environment using the mitigation operation.

2. The system of claim 1, wherein the incident includes at least one of a service halt incident, a service slow down incident, a user experience incident, a user interface incident, or a service inaccuracy incident.

3. The system of claim 1, wherein the rule is associated with at least one of the following: a processing thread quantity requirement, a network port access requirement, a security level access requirement, a storage capacity requirement, or a minimum memory quantity requirement.

4. The system of claim 1, wherein configuring the second environment includes:
identifying a configuration of the first environment;
determining a scale factor based on resources used in the configuration of the first environment and on resources available for use in a configuration of the second environment; and
creating the second environment using the configuration of the first environment and the scale factor, wherein the second environment is scaled down from the first environment based on the scale factor.

5. The system of claim 4, wherein deploying the service to the second environment includes scaling down the rule using the scale factor; and
wherein determining that the incident is resolved in the second environment includes determining that the scaled down rule is satisfied during the execution of the modified service in the second environment.

6. The system of claim 4, wherein executing the modified service deployed to the second environment includes directing duplicate traffic to the modified service deployed to the second environment, wherein the duplicate traffic is duplicated from traffic directed to the service deployed in the first environment; and
wherein a quantity of the directed duplicate traffic to the modified service deployed to the second environment is scaled down using the scale factor.

7. The system of claim 1, wherein the mitigation operation includes at least one of the following: an operation adjusting a quantity of processing resources allocated to the service, an operation adjusting a quantity of memory resources allocated to the service, an operation adjusting a rate at which traffic is directed to the service, an operation rolling back the service to a previous version, or an operation adjusting a frequency with which a subprocess of the service is performed.

8. A computerized method comprising:
detecting an incident associated with a service deployed in a first environment;
determining a rule associated with the service, wherein the rule describes a requirement of the service;
determining a mitigation operation to address the incident using a solution generator model, wherein the mitigation operation satisfies the rule;
deploying the service to a second environment, wherein the second environment is scaled down compared to the first environment;
modifying the service deployed to the second environment using the mitigation operation;
directing duplicate traffic to the modified service deployed to the second environment, wherein the duplicate traffic is scaled down relative to traffic directed to the service deployed in the first environment;
determining that the incident is addressed with respect to the modified service deployed to the second environment based at least in part on directing the duplicate traffic to the modified service; and
modifying the service deployed in the first environment using the mitigation operation.

9. The computerized method of claim 8, wherein the incident includes at least one of a service halt incident, a service slow down incident, a user experience incident, a user interface incident, or a service inaccuracy incident.

10. The computerized method of claim 8, wherein the rule is associated with at least one of the following: a processing thread quantity requirement, a network port access requirement, a security level access requirement, a storage capacity requirement, or a minimum memory quantity requirement.

11. The computerized method of claim 8, wherein deploying the service to the second environment includes:
identifying a configuration of the first environment;
determining a scale factor based on resources used in the configuration of the first environment and on resources available for use in a configuration of the second environment; and
creating the second environment using the configuration of the first environment and the scale factor, wherein the second environment is scaled down from the first environment based on the scale factor.

12. The computerized method of claim 11, wherein deploying the service to the second environment includes scaling down the rule using the scale factor; and
wherein determining that the detected incident is addressed with respect to the modified service deployed to the second environment includes determining that the scaled down rule is satisfied during the directing of the duplicate traffic to the modified service deployed to the second environment.

13. The computerized method of claim 11, wherein a quantity of the directed duplicate traffic to the modified service deployed to the second environment is scaled down using the scale factor.

14. The computerized method of claim 8, wherein the mitigation operation includes at least one of the following: an operation adjusting a quantity of processing resources allocated to the service, an operation adjusting a quantity of memory resources allocated to the service, an operation adjusting a rate at which traffic is directed to the service, an operation rolling back the service to a previous version, or an operation adjusting a frequency with which a subprocess of the service is performed.

15. A computer storage medium has computer-executable instructions that, upon execution by a processor, cause the processor to at least:
determine, using a solution generator model, a first mitigation operation associated with an incident and a service deployed to a first environment, wherein the first mitigation operation satisfies a rule associated with a requirement of the service;
deploy the service to a second environment, wherein the second environment is scaled down compared to the first environment;
modify the service deployed to the second environment using the first mitigation operation;
execute the modified service deployed to the second environment using the first mitigation operation;
determine that the incident is not addressed with respect to the modified service deployed to the second environment;
determine a second mitigation operation to address the incident associated with the service deployed to the first environment using the solution generator model, wherein the second mitigation operation satisfies the rule;
modify the service in the second environment using the second mitigation operation;
execute the modified service redeployed to the second environment using the second mitigation operation;
determine that the incident is resolved; and
modify the service deployed in the first environment using the second mitigation operation.

16. The computer storage medium of claim 15, wherein the incident includes at least one of a service halt incident, a service slow down incident, a user experience incident, a user interface incident, or a service inaccuracy incident.

17. The computer storage medium of claim 15, wherein deploying the service to the second environment includes:
identifying a configuration of the first environment;
determining a scale factor based on resources used in the configuration of the first environment and on resources available for use in a configuration of the second environment; and
creating the second environment using the configuration of the first environment and the scale factor, wherein the second environment is scaled down from the first environment based on the scale factor.

18. The computer storage medium of claim 17, wherein deploying the service to the second environment includes scaling down the rule using the scale factor; and
wherein determining that the incident is resolved includes determining that the scaled down rule is satisfied during the execution of the modified service deployed to the second environment.

19. The computer storage medium of claim 17, wherein executing the modified service deployed to the second environment includes directing duplicate traffic to the modified service deployed to the second environment, wherein the duplicate traffic is duplicated from traffic directed to the service deployed in the first environment; and
wherein a quantity of the directed duplicate traffic to the modified service deployed to the second environment is scaled down using the scale factor.

20. The computer storage medium of claim 15, wherein the second mitigation operation includes at least one of the following: an operation adjusting a quantity of processing resources allocated to the service, an operation adjusting a quantity of memory resources allocated to the service, an operation adjusting a rate at which traffic is directed to the service, an operation rolling back the service to a previous version, or an operation adjusting a frequency with which a subprocess of the service is performed.
